(19) United States
(12) Patent Application Publication
(10) Pub. No.: US 2025/0073625 A1
(43) Pub. Date: Mar. 6, 2025

(54) FAUCET

(71) Applicant: Adams Rite Aerospace Inc., Fullerton, CA (US)

(72) Inventors: Nera-Lee Patel, Pasadena, CA (US); Juan Pena, Ontario, CA (US); Matt Scholvinck, Huntington Beach, CA (US); Matthew Timsit, Tustin, CA (US); Daniel Lau, Torrance, CA (US)

(21) Appl. No.: 18/820,465

(22) Filed: Aug. 30, 2024

Related U.S. Application Data
(60) Provisional application No. 63/535,797, filed on Aug. 31, 2023.

(51) Int. Cl. B01D 35/04; B01D 35/157; C02F 1/00

(52) U.S. Cl. CPC B01D 35/046; B01D 35/1573; C02F 1/003; B01D 2201/29; B01D 2201/34; B01D 2201/4053; B01D 2201/4092; C02F 2201/004; C02F 2201/005; C02F 2201/006; C02F 2307/06

(57) ABSTRACT

Provided is a faucet including a faucet body having first and second ends and a through passage, a faucet cap positioned at the first end of the faucet body and movable relative to the faucet body, and a cartridge having a cartridge body disposed in the through passage and a cartridge cap connected to the faucet cap and movable relative to the cartridge body and faucet body, the cartridge body having a mixing chamber that receives fluid from one or more fluid sources, the mixing chamber being non-concentric to allow for a linear volume change rate during rotation of the faucet cap.

### RELATED APPLICATIONS

This application claims the benefit of U.S. Provisional Application No. 63/535,797 filed Aug. 31, 2023, which is hereby incorporated herein by reference.

### FIELD OF INVENTION

The present invention relates generally to a faucet, and more particularly to a mechanically timed and temperature adjustable faucet.

### BACKGROUND

Water is one of the necessary loads carried by an aircraft. In commercial aviation, it is desirable to use the minimum amount, yet have sufficient water available to satisfy the requirements of the passengers and crew. A mechanical device can be provided that automatically closes a valve in a conduit supplying water to the faucet after a predetermined period.

### SUMMARY OF INVENTION

In accordance with one aspect of the application, a faucet is provided that includes a faucet body having first and second ends and a through passage extending therethrough, a faucet cap positioned at the first end of the faucet body and movable relative to the faucet body, a cartridge having a cartridge body disposed in the through passage and a cartridge cap connected to the faucet cap and movable relative to the cartridge body and faucet body, the cartridge body having a mixing chamber that receives fluid from one or more fluid sources, the mixing chamber being non-concentric to allow for a linear volume change rate during rotation of the faucet cap.

In accordance with another aspect of the application, a faucet is provided including a faucet body having first and second ends and a through passage extending therethrough, a faucet cap positioned at the first end of the faucet body and movable relative to the faucet body in a radial and a longitudinal direction, a cartridge having a cartridge body disposed in the through passage and a cartridge cap connected to the faucet cap and movable relative to the cartridge body and faucet body in the longitudinal direction, the cartridge body having a first chamber and a second chamber, and a filter disposed in the second chamber and removably connected to the second chamber.

In accordance with still another aspect of the application, a faucet is provided including a faucet body having first and second ends and a through passage extending therethrough, the through passage having a first portion with a first diameter and a second portion with a second diameter greater than the first diameter, wherein a shoulder is formed between the first and second portions, a faucet cap positioned at the first end of the faucet body, a cartridge having a cartridge body disposed in the through passage and a cartridge cap connected to the faucet cap, the cartridge body having first and second ends, a first outer portion near the first end, a second outer portion, a third outer portion, and a fourth outer portion near the second end, wherein a ledge is formed between the third and fourth outer portions, wherein the cartridge body is insertable into the through passage at the second end of the faucet body and the ledge abuts the shoulder to prevent movement of the cartridge body in a direction toward the first end of the faucet body.

The foregoing and other features of the application are described below with reference to the drawings.

### BRIEF DESCRIPTION OF THE DRAWINGS

FIG. 1 is a perspective view of an exemplary faucet attached to a structure.

FIG. 2 is another perspective view of the faucet attached to the structure showing a faucet body and cap in cross-section.

FIG. 3 is an exploded view of a cartridge assembly.

FIG. 4 is a cross-sectional view of a cartridge body.

FIG. 5 is a cross-sectional view of the faucet taken from a rear of the faucet.

FIG. 6 is a cross-sectional view of the faucet taken about line 6-6 in FIG. 1.

FIG. 7 is a perspective view of a filter.

FIG. 8 is a cross-sectional view of the filter taken about line 8-8 in FIG. 10.

FIG. 9 is a side view of the filter.

FIG. 10 is an end view of the filter.

FIG. 11 is a front view of the faucet with a portion cutaway.

FIG. 12 is top view of the faucet of FIG. 11 showing the cross-section.

FIG. 13 is a front view of the faucet with a portion cutaway.

FIG. 14 is top view of the faucet of FIG. 13 showing the cross-section.

FIG. 15 is a front view of the faucet with a portion cutaway.

FIG. 16 is top view of the faucet of FIG. 15 showing the cross-section.

FIG. 17 is a cross-sectional view illustrating the faucet of FIG. 6 in an unactuated position.

FIG. 18 is a cross-sectional view illustrating the faucet of FIG. 6 in an actuated position.

### DETAILED DESCRIPTION

The principles of the present application relate to a faucet, such as a faucet for use on an aircraft, and thus will be described below in this context. It will be appreciated that the principles of the application may be applicable to faucets and water delivery devices in other suitable locations, such as public restrooms, building lobbies, etc.

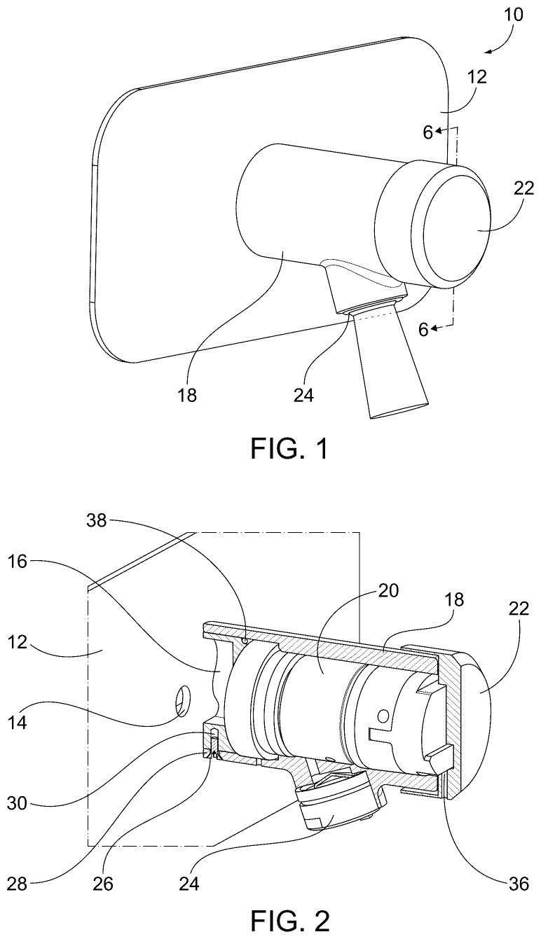

Turning now to FIGS. 1 and 2, a faucet is shown generally at reference numeral 10. The faucet 10 is configured to attach to a structure 12, such as a panel or wall of an aircraft lavatory. The structure 12 includes one or more openings 14 through which conduits extend to connect the faucet 10 to a fluid source, such as a hot and cold water source. The faucet 10 includes an installation base 16 that attaches to the structure 12 and the conduits, a faucet body 18 that surrounds the installation base 16 and abuts the structure 12, a cartridge 20 disposed in the faucet body 18, a faucet cap 22 attached to the cartridge 20, and an aerator 24 disposed in the faucet body 18 through which water exits the faucet 10.

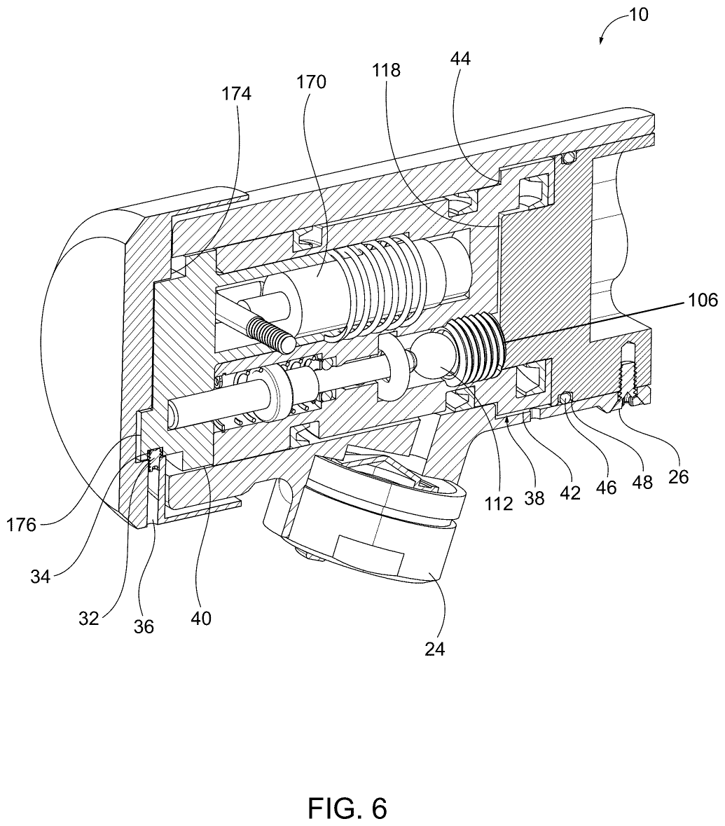

The faucet body 18 can be removably attached to the installation base 16, for example to allow for customization, repairs, replacement, etc., via a fastener 26 that extends through corresponding openings 28 and 30 in the faucet body 18 and installation base 16. The mounting interaction between the faucet body 18 and the installation base 16 allows an installer to remove/replace the faucet without access to a backside of the structure 12. Similarly, as shown in FIG. 6, the faucet cap 22 can be removably attached to the cartridge 20 via a fastener 32 that extends through corresponding openings 34 and 36 in the cartridge 20 and the faucet cap 22. The faucet body 18 includes a through passage 38 having a first portion 40 with a first diameter and a second portion 42 with a second diameter greater than the first diameter. A shoulder 44 is provided between the first and second portions and the installation base 16 can be sealed to the second portion 42 in any suitable manner, such as by seal 46 in a seal groove 48 on an outer surface of the installation base 16.

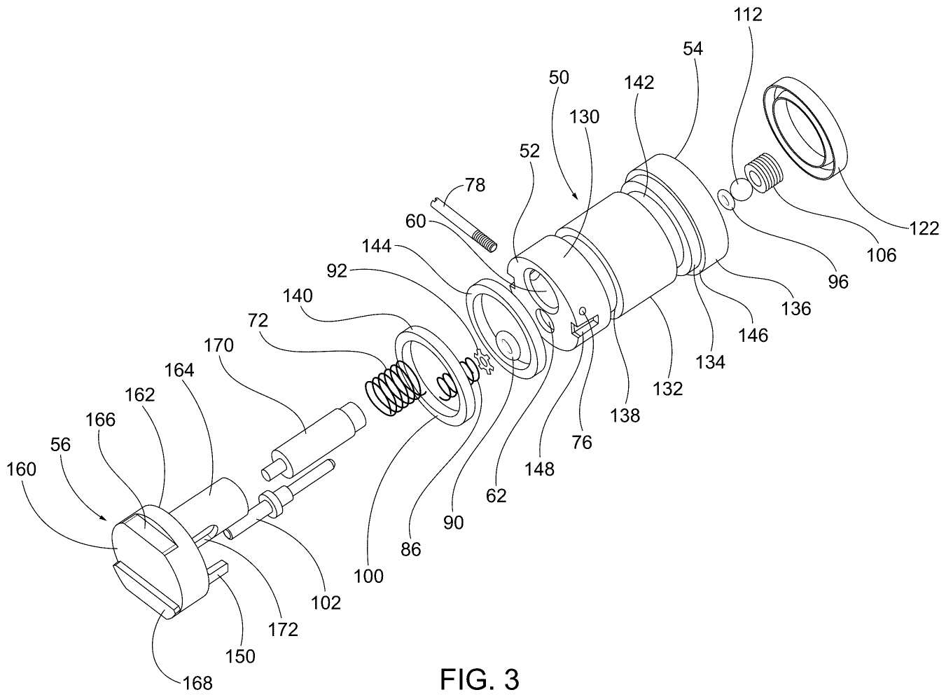

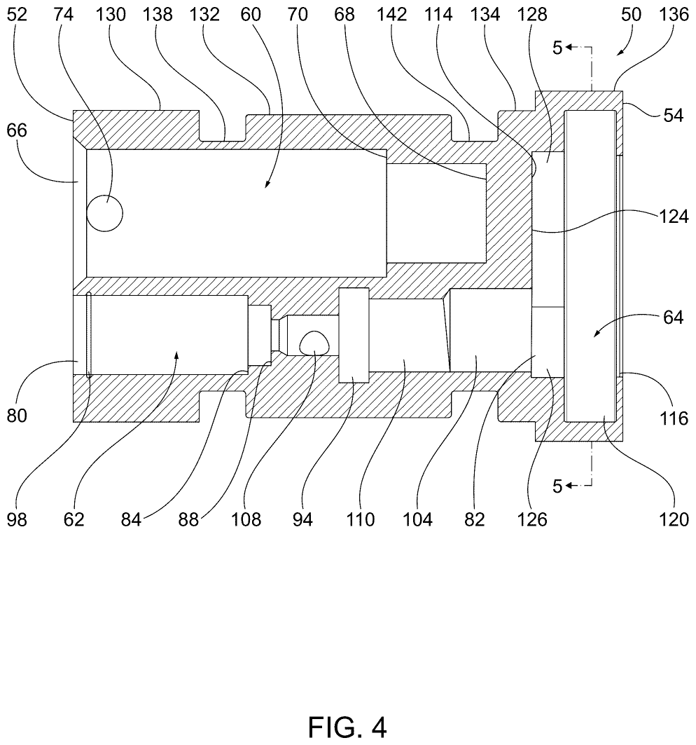

Referring now to FIGS. 3 and 4, the cartridge 20 will be described in detail. The cartridge 50 can be inserted into the through passage 38 of the faucet body 18 from the backside of the faucet body 18 opposite the faucet cap 22. The cartridge 20 includes a cartridge body 50 having a first end 52 and a second end 54, and a cartridge cap 56 attached to the cartridge body 50 at the first end 52. The cartridge body 50 includes a first chamber 60, a second chamber 62 parallel to the first chamber 60, and a third chamber 64 in fluidic communication with the second chamber 62. The first chamber 60 has a first end 66 opening to the first end 52 of the cartridge body 50 and a second end 68 that is a closed end. The first chamber 60 also has a shoulder 70 that serves as a spring seat for a spring 72 and opening 74 and 76 extending into the first chamber 60 for receiving a pin 78. The pin 78 is secured in the openings and remains fixed in position with the cartridge body 50

The second chamber 62 has a first end 80 opening to the first end 52 of the cartridge body 50 and a second end 82 opening to the third chamber 64 and serving as an inlet. The second chamber 62 also has a first shoulder 84 that serves as a spring seat for a spring 86, a second shoulder 88 that serves as a seat for a seal 90 held in position by retainer 92, a seal groove 94 that receives a seal 96, and a groove 98 for receiving a retainer ring 100 for holding a piston 102 in position. The second chamber 62 additionally includes a filter chamber 104 at the second end 82 that receives a filter 106 at the inlet, an opening 108 that extends into the second chamber 62 that serves as an outlet, and a valve chamber 110 through which a valve 112, such as a ball valve moves during operation. The filter chamber 104 is non-concentric with the valve chamber 110 to provide a stop for the filter 106 during installation and to allow the filter 106 to serve as a stop for the valve 112 without blocking the flow passage through the filter 106.

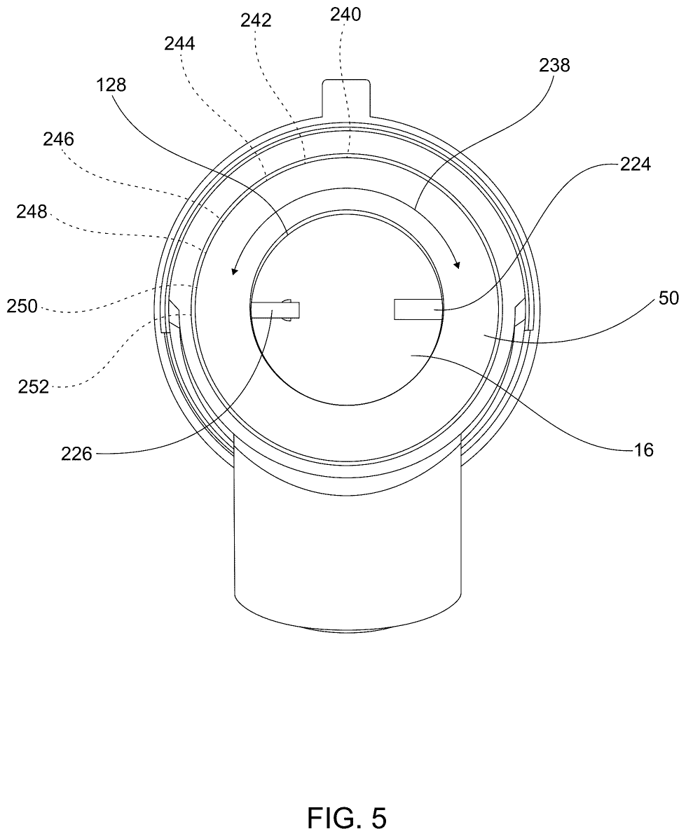

Turning additionally to FIG. 5, the third chamber 64 has a first end 114 opening to the second chamber 62 and a second end 116 opening to the second end 54 of the cartridge body 50. The third chamber 64 is configured to receive an end 118 (FIG. 6) of the installation base 16 and has a seal groove 120 for receiving a suitable seal 122, such as a u-cup seal that seals to the installation base 16. The third chamber 64 also has a mixing region or chamber 124 that receives fluid flowing through installation base 16. The mixing region has a first portion 126 that is concentric with the installation base 16 and a second portion 128 that is non-concentric with the installation base as shown in FIG. 5. As shown, the second portion 128 has an ovoid shape creating a gap between the installation base 16 and the second portion 128.

The cartridge 20 is pressure balanced in the faucet body 18 such that the cartridge body 56 is not pressed forward into the shoulder 44 or backward into the installation base 16 by pressure flowing through the faucet 10 in such a way as to make turning of the faucet cap 22 difficult during operation. The cross-sectional area at the u-cup seal 122 pushing the cartridge body 56 backward is equal to or substantially equal to the cross-sectional area at the mixing region 124 pushing the cartridge body 56 forward to pressure balance or substantially pressure balance the system with a constant pressure flowing therethrough to allow for easy turning of the faucet cap 22 during operation.

The outer surface of the cartridge body 50 includes a first outer portion 130 having a first diameter, a second outer portion 132 having a second diameter, a third outer portion 134 having a third diameter, and a fourth outer portion 136 having a fourth diameter. The diameters of the first and third outer portions 130 and 134 are the same or substantially the same, the diameter of the second outer portion 132 is less than the diameters of the first and third outer portions 130 and 134 to provide a flow path between the second outer portion 132 and the first portion 40 of the through passage 38, and the diameter of the fourth outer portion 136 is greater than the diameters of the other portions. The outer surface of the cartridge body 50 also has a first seal groove 138 between the first and second outer portions 130 and 132 for receiving a seal 140, and a second seal groove 142 between the second and third outer portions 132 and 134 for receiving a seal 144. The seals 140 and 144, which may be suitable seals such as u-cup seals, seal a flow passage 152 between the second outer portion 132, the first portion 40 of the through passage 38, and the outlet 108. A ledge 146 is defined between the third and fourth outer portions 134 and 136 that is configured to abut or otherwise be in close proximity to the shoulder 44 of the faucet body 18, and slots 148 are provided on sides of the first outer portion 130 for receiving corresponding projections 150 on the cartridge cap 56 that prevent rotation of the cartridge cap 56 relative to the cartridge body 50.

Turning additionally to FIG. 6, the cartridge cap 56 will be discussed in detail. The cartridge cap 56 has first and second ends 160 and 162, a hollow projection 164 projecting from the second end 162, the projections 150 projecting from the second end 162, one or more flats 166 on sides of the cartridge cap 56, and a projection 168 projecting from the first end 160. The hollow projection 164 is configured to extend into the first chamber 60 to receive an end of a dampening mechanism 170 and to serve as a seat for the spring 72. The hollow projection 168 includes a slot 172 on either side through which the pin 78 extends. The flats 166 are configured to abut a shoulder 174 on an underside of the faucet cap 22 to prevent rotation of the cap 22 relative to the cap 56. The projection 168 is configured to extend into a slot 176 on the underside of the faucet cap 22 and includes the opening 34 for receiving the fastener 32 to secure the faucet cap 22 to the cartridge cap 56. The connection allows the rotation of the faucet cap 22 to effect rotation of the cartridge cap 56 and cartridge body 50 to adjust the temperature of the water output from the faucet 10.

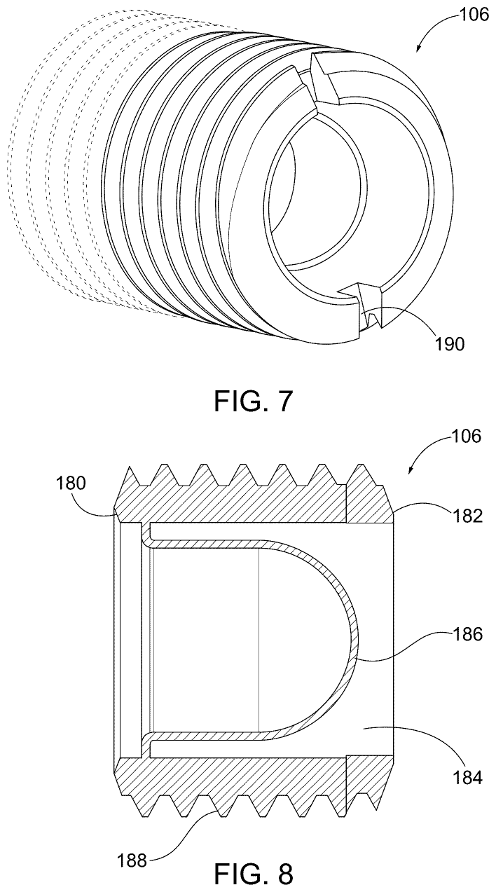

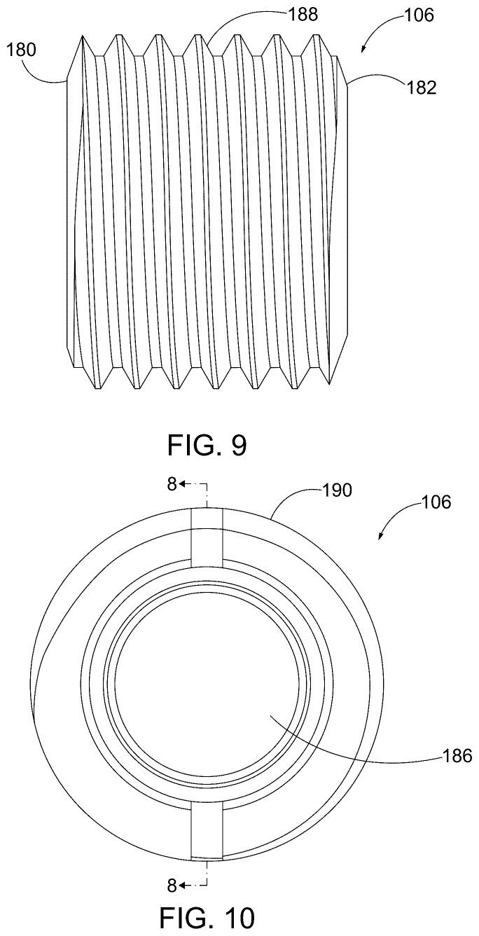

Turning now to FIGS. 7-10, the filter 106 will be described in detail. The filter 106 has a first end 180, a second end 182, and a through passage 184. A screen 186 is disposed in the through passage 184 and attached to an inner surface thereof to filter particulates from the fluid flowing from the fluid source to protect and extend the life of the faucet 10 without the need for an external filter. The filter includes threads 188 on an outer surface thereof that mate with threads on an inner surface of the filter chamber 104 to secure the filter 106 in the filter chamber 104. The filter 106 also includes a keyway 190 at the second end 182 for a user to insert a tool to tighten and loosen the filter 106. As shown, the keyway 190 is in the form of one or more slots. The filter is removable to clean the screen or to allow another filter to be installed in the field.

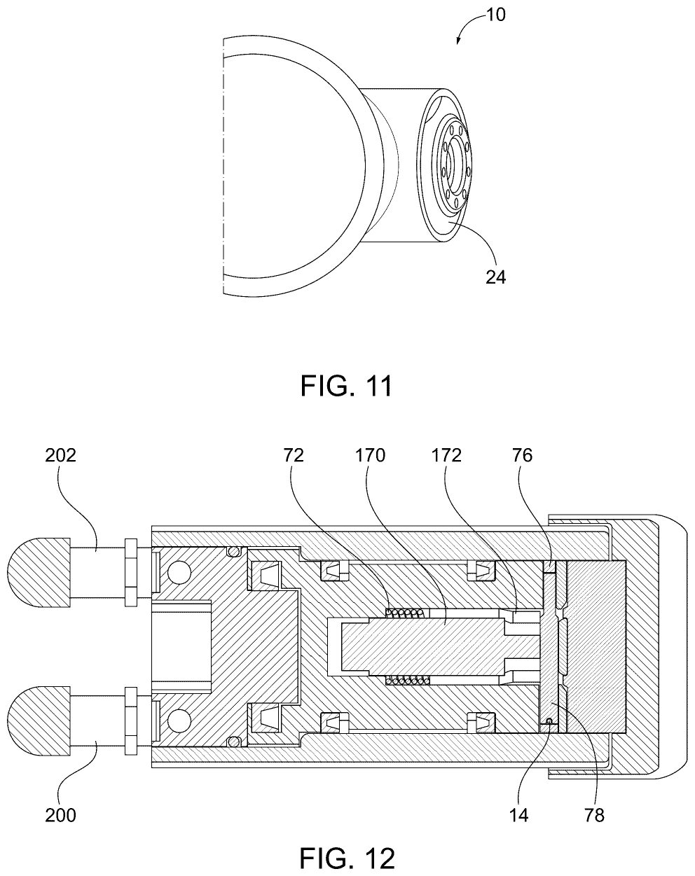

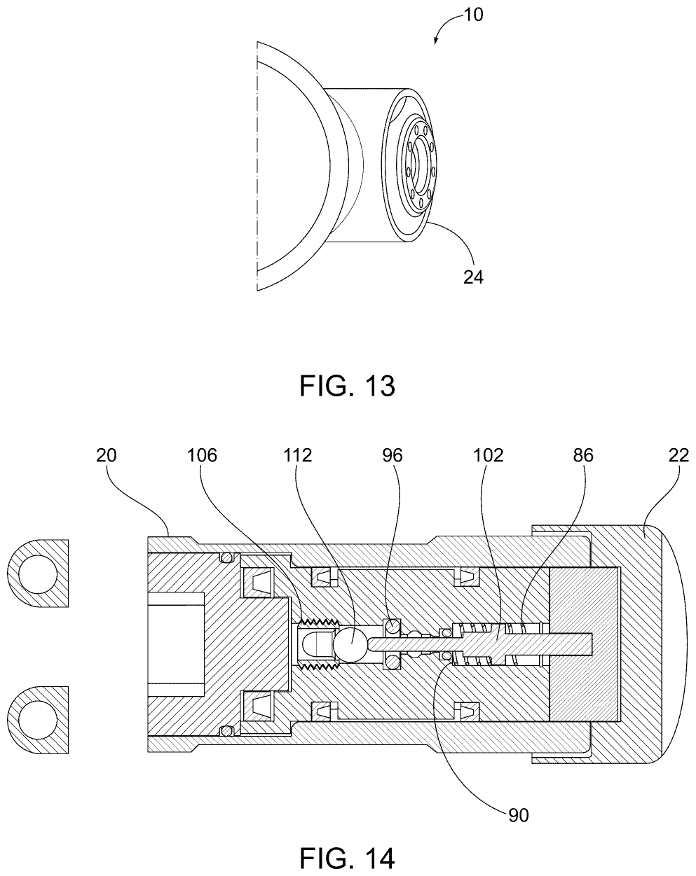

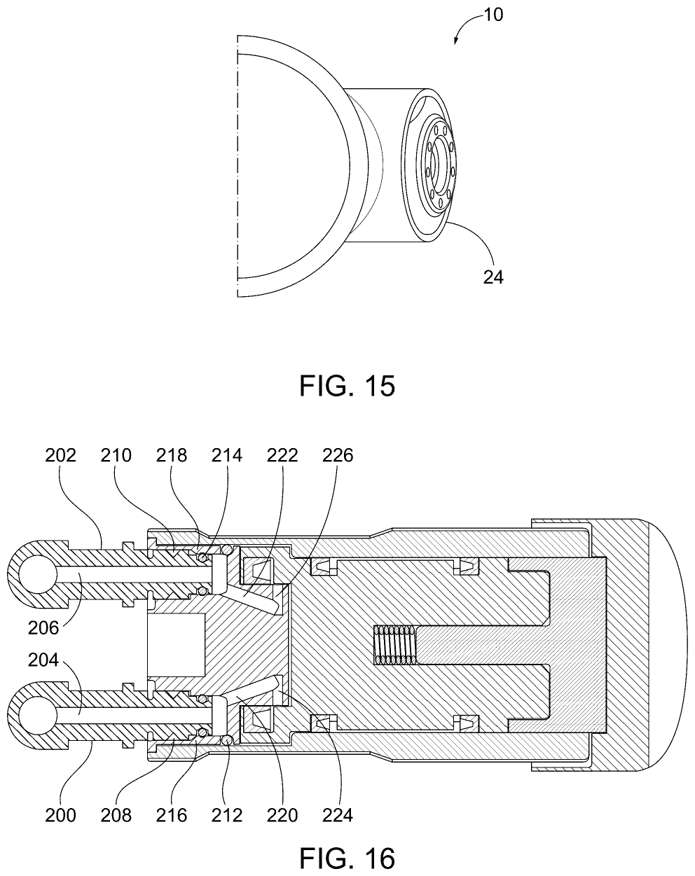

Turning now to FIGS. 11-16, the aircraft includes first and second conduits 200 and 202, for example a cold water conduit and a hot water conduit, that each extend through one of the openings 14 in the structure 16 and have respective passages 204 and 206 extending therethrough. The first and second conduits 200 and 202 are received in respective passages 208 and 210 in the installation base 16 and secured in a suitable manner, such as by a threaded connection. The first and second conduits 200 and 202 can be sealed to the installation base by a suitable seal 212, 214 received in a respective seal groove 216, 218 on outer surfaces of the first and second conduits 200 and 202.

The passages 208 and 210 in the installation base 16 are connected to respective passages 220 and 222, which are shown as angled passages, that are connected to respective passages 224 and 226, which are shown as radially outwardly extending passages. The passage 220 in communication with the first or cold water conduit 200 is larger than the passage 222 in communication with the second or hot water conduit 202 to provide more cold water flow into the mixing chamber than hot water flow to provide scalding protection. The water flows from the passages 220 and 222 into the mixing chamber 124 where it mixes and then can enter the filter chamber 104 via the inlet 82.

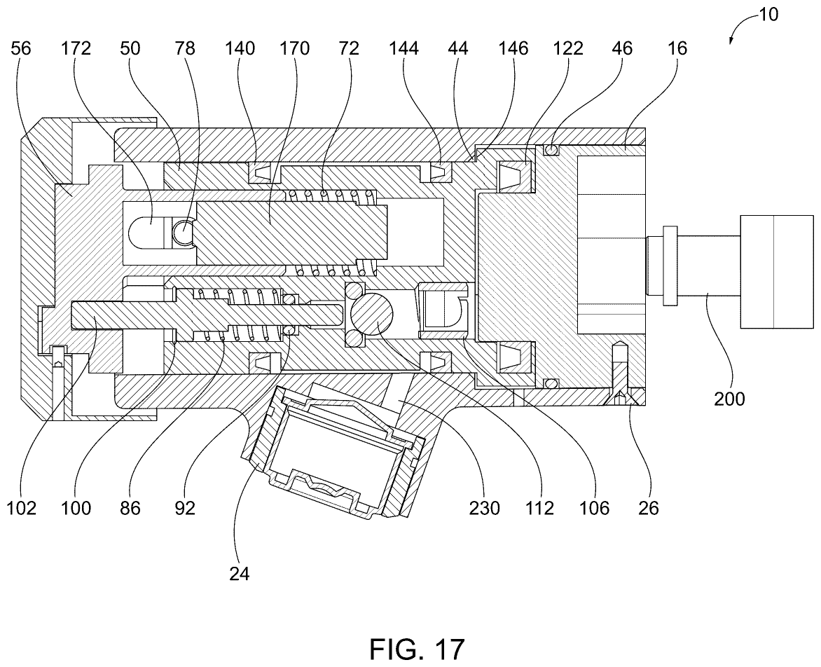

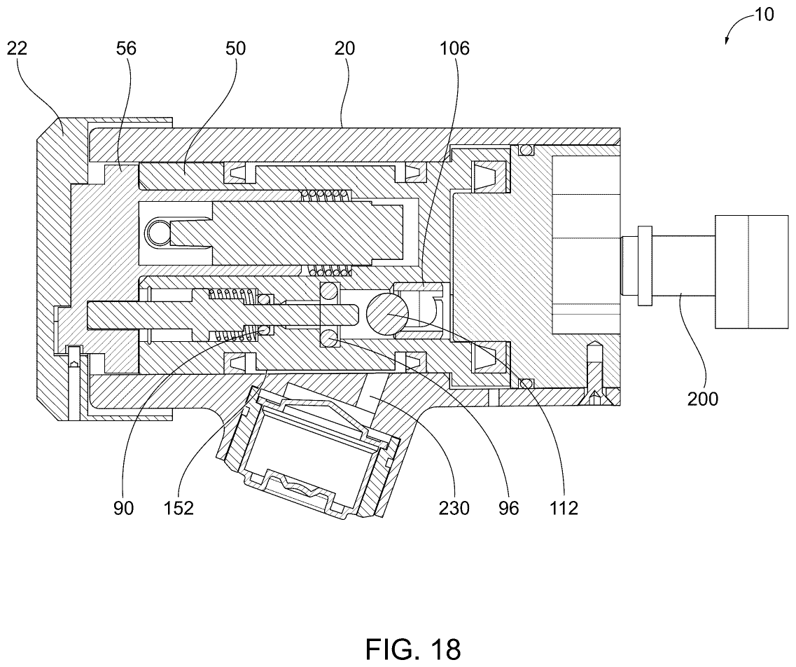

Referring additionally to FIGS. 17 and 18, the operation of the faucet 10 will be described in detail. FIG. 17 shows the faucet 10 in its unactuated position where fluid pressure is action on the system but fluid is not exiting the faucet. In this position, the ball valve 112 is seated against the seal 96 preventing water in the mixing chamber 124 from flowing through the outlet 108 and out of the aerator 24. FIG. 18 shows the faucet 10 in its actuated position where water exits via the aerator 24 for a fixed period of time as shown in FIG. 1. When there is no fluid pressure action on the system, the value moves to its unseated position allow for venting.

When a user activates the faucet 10 by pushing the faucet cap 22 in a first direction towards the structure 16, the cartridge cap 56 is moved in the first direction. The movement moves the hollow projection 164 to compress the spring 72, moves the piston 102 to compress the spring 86, and causes the dampening mechanism 170, which may be a hydraulic timing mechanism, to be released and decompress.

When the piston 102 is moved in the first direction, an end of the piston 102 opens the valve 112 by moving the valve 112 from its seated position against the seal 96 to an unseated position adjacent the first end 180 of the filter 106. The open valve 112 allows water from the conduits 200 and 202 to flow through the mixing chamber 124, the filter chamber 104, the valve chamber 110, and the seal 96 through the opening 108. The water exits the opening 108 into the flow passage 152 between the second outer portion 132 of the cartridge 50 and the first portion 40 of the through passage 38. The water then flows through an outlet passage 230 in the faucet body 18 that connects the flow passage 152 to the aerator 24.

After the user activates the faucet 10, the springs 72 and 86 move the faucet cap 22 in a second direction opposite the first direction and work against the dampening mechanism 170, which causes the faucet 10 to operate for a predetermined period of time as the dampening mechanism 170 is moved back to its compressed state. The water flows through the aerator 24 until the dampening mechanism is moved back to its compressed state.

The temperature of the water flowing through the faucet 10 can be adjusted before, during, or after operation of the faucet 10. To adjust the temperature, the faucet cap 22 is rotated to one side or the other. When the faucet cap 22 is rotated radially, the water temperature changes at a linear change rate to effect a smooth transition of temperature due to the second portion 128 of the mixing chamber 124 being non-concentric.

For example, if the faucet cap 22 and therefore the cartridge 50 is rotated illustrated at 238 relative to the installation base 16 from a neutral position shown by line 240 in FIG. 5 to the right by x degrees shown by line 242, the amount of hot water entering the mixing chamber 124 from the passage 226 will increase by x units as the gap between the installation base 16 and wall of the second portion 128 of the mixing chamber 124 increases. If the faucet cap 22 is turned from the neutral position to the right by 2x degrees shown by line 244, the amount of hot water entering the mixing chamber will increase by 2x units. The linear volume flow rate change will continue as the faucet cap is turned by 3x degrees, 4x degrees, 5x degrees, and 6x degrees shown by lines 246, 248, 250, and 252. Similarly, if the faucet cap 22 and therefore the cartridge 50 is rotated relative to the installation base 16 from a neutral position to the left by x degrees, the amount of cold water entering the mixing chamber 124 from the passage 224 will increase by x units as the gap between the installation base 16 and wall of the second portion 128 of the mixing chamber 124 increases. If the faucet cap 22 is turned from the neutral position to the left by 2x degrees, the amount of hot water entering the mixing chamber will increase by 2x units, etc. As the faucet cap 22 is rotated, the gap between the installation base 16 and the wall of the second portion 128 increases to increase the flow through the passages 224 and 226.

Although certain embodiments have been shown and described, it is understood that equivalents and modifications falling within the scope of the appended claims will occur to others who are skilled in the art upon the reading and understanding of this specification.

What is claimed is:

1. A faucet comprising:
a faucet body having first and second ends and a through passage extending therethrough;
a faucet cap positioned at the first end of the faucet body and movable relative to the faucet body;
a cartridge having a cartridge body disposed in the through passage and a cartridge cap connected to the faucet cap and movable relative to the cartridge body and faucet body, the cartridge body having a mixing chamber that receives fluid from one or more fluid sources, the mixing chamber being non-concentric to allow for a linear volume change rate during rotation of the faucet cap.

2. The faucet according to claim 1, wherein the cartridge body includes a first chamber, a second chamber parallel to the first chamber, and a third chamber in fluidic communication with the second chamber, the third chamber including the mixing chamber.

3. The faucet according to claim 2, further comprising a filter disposed in and removably connected to the second chamber, wherein the fluid flows from the mixing chamber and through the filter to filter out particulates from the fluid.

4. The faucet according to claim 3, wherein the filter includes a keyway at an end for receiving a tool to tighten and loosen the filter.

5. The faucet according to claim 2, further including a dampening mechanism disposed in the first chamber that provides for a timed release of fluid and a valve disposed in the second chamber, the valve being movable between a seated position preventing flow through the second chamber and an unseated position allowing flow through the second chamber.

6. The faucet according to claim 1, further comprising an installation base connected to the one or more fluid sources and including a head disposed in the mixing chamber and having first and second passages that direct fluid into the mixing chamber, wherein the head is non-concentric with the mixing chamber.

7. The faucet according to claim 6, wherein the cartridge body is rotatable relative to the installation base, and wherein rotation of the cartridge body to a first side causes a gap between a wall of the mixing chamber and the first passage to increase, and rotation of the cartridge body to a second side causes a gap between the wall of the mixing chamber and the second passage to increase.

8. The faucet according to claim 6, wherein the first passage has a first diameter and the second passage has a second diameter less than the first passage.

9. The faucet according to claim 6, wherein the faucet body is removably attached to the installation base by a fastener.

10. A faucet comprising:
a faucet body having first and second ends and a through passage extending therethrough;
a faucet cap positioned at the first end of the faucet body and movable relative to the faucet body in a radial and a longitudinal direction;
a cartridge having a cartridge body disposed in the through passage and a cartridge cap connected to the faucet cap and movable relative to the cartridge body and faucet body in the longitudinal direction, the cartridge body having a first chamber and a second chamber; and
a filter disposed in the second chamber and removably connected to the second chamber.

11. The faucet according to claim 10, wherein the filter has a first end, a second end, a through passage extending therethrough, and a screen disposed in the through passage.

12. The faucet according to claim 10, wherein the filter includes threads on an outer surface that mate with corresponding threads on an inner surface of the second chamber to connect the filter to the second chamber.

13. The faucet according to claim 12, wherein the filter includes a keyway for receiving a tool to tighten and loosen the filter.

14. The faucet according to claim 10, wherein fluid enters the second chamber, flows through the filter to filter out particulates from the fluid, and exits the filter to an outlet in the second chamber.

15. The faucet according to claim 10, further including a valve disposed in the second chamber, the valve being movable between a seated position preventing flow through the second chamber and an unseated position allowing flow through the second chamber, and wherein the filter serves as a stop for the valve in the unseated position.

16. A faucet comprising:
a faucet body having first and second ends and a through passage extending therethrough, the through passage having a first portion with a first diameter and a second portion with a second diameter greater than the first diameter, wherein a shoulder is formed between the first and second portions;
a faucet cap positioned at the first end of the faucet body;
a cartridge having a cartridge body disposed in the through passage and a cartridge cap connected to the faucet cap, the cartridge body having first and second ends, a first outer portion near the first end, a second outer portion, a third outer portion, and a fourth outer portion near the second end, wherein a ledge is formed between the third and fourth outer portions,
wherein the cartridge body is insertable into the through passage at the second end of the faucet body and the ledge abuts the shoulder to prevent movement of the cartridge body in a direction toward the first end of the faucet body.

17. The faucet according to claim 16, wherein the first outer portion has a first diameter, the second outer portion has a second diameter, the third outer portion has a third diameter, and the fourth outer portion has a fourth diameter, wherein the first and third diameters are the same, the second diameter is less than the first diameter, and the fourth diameter is greater than the first diameter.

18. The faucet according to claim 16, wherein a first seal groove is formed between the first and second outer portions and a second seal groove is formed between the second and third outer portions, and wherein a seal is received in each groove.

19. The faucet according to claim 18, wherein a flow passage is formed between the second outer portion and the first portion of the through passage of the faucet body, and wherein the seals seal the flow passage.

20. The faucet according to claim 16, further comprising an installation base, the installation base configured to be disposed in the second portion of the through passage and having a ledge abutting the second end of the cartridge body.
